(19) United States
(12) Patent Application Publication
(10) Pub. No.: US 2017/0194888 A1
(43) Pub. Date: Jul. 6, 2017

(54) Self-Excitation Traction Alternator for Locomotive

(71) Applicant: Electro-Motive Diesel, Inc., LaGrange, IL (US)

(72) Inventor: Madan M. Jalla, Woodridge, IL (US)

(73) Assignee: Electro-Motive Diesel, Inc., LaGrange, IL (US)

(21) Appl. No.: 14/988,227

(22) Filed: Jan. 5, 2016

(51) Int. Cl. H02P 9/38; H02P 3/22

(52) U.S. Cl. CPC H02P 9/38; H02P 3/22

(57) ABSTRACT

A self-excitation system for a locomotive having at least a primary mover is provided. The self-excitation system may include a traction alternator, a permanent magnet machine, and a chopper circuit. The traction alternator may include an alternator stator and an alternator rotor mechanically coupled to a drive shaft of the primary mover. The permanent magnet machine may include a machine stator and a machine rotor mechanically coupled to the drive shaft. The chopper circuit may be configured to receive electrical signals from the machine stator and control a field excitation of the traction alternator.

### TECHNICAL FIELD

The present disclosure relates generally to electric drive systems for locomotives, and more particularly, to systems and devices for traction alternators.

### BACKGROUND

Traction alternators are commonly used in locomotives to supply electrical power to traction motors, which are used to propel the locomotive. The driving force behind the traction alternator itself is typically provided by a combination of mechanical input from a primary mover, such as a combustion engine, or the like, and electromagnetic interactions with a source of field excitation. Moreover, a companion alternator which is commonly driven by the same primary mover, or drive shaft thereof, is used to supply electrical power to a field chopper circuit, which in turn, supplies the traction alternator with the field excitation needed to generate electrical power to the attached traction motors. The companion alternator may also be used to supply power to various auxiliary loads of the locomotive.

As disclosed in U.S. Publication No. 2013/0079959 (“Swanson”), for example, a power system for a locomotive is shown having both a companion alternator and a traction alternator. In Swanson, the companion alternator drives a traction alternator field regulator, which then provides the field excitation needed by the traction alternator to generate electrical power to the power switching components associated with the traction motors. Although such conventional arrangements may be adequate for operating a locomotive, there is still much room for improvement. Among other things, some common goals in the locomotive industry generally include reducing costs of implementation and maintenance, shedding weight, and providing more simplified power schemes. One such improvement aims to overcome the need for the companion alternator, which if feasible, can help avoid the complexity, weight and costs associated with having an additional alternator on board.

The companion alternator may be omitted if, for example, electrical power output to auxiliary loads from the traction alternator can be fed back into a field chopper circuit and used to drive the traction alternator in a closed loop format. Although such an arrangement removes the need for an additional companion alternator, the feedback loop poses other potential problems. For instance, an electrical fault in any one of the several inverters, rectifiers and other supporting circuitries associated with the traction alternator, or in any of the inverters, rectifiers and circuitries associated with the auxiliary loads may adversely affect the field chopper circuit and thus the field excitation of the traction alternator. In addition, potential of adverse effects on the overall power system are further compounded by the high-voltage nature of the traction alternator and the possibility of reintroducing high-voltage errors in its output back into its input.

In view of the foregoing disadvantages associated with locomotives and conventional electric drive systems, a need therefore exists for more simplified and yet reliable power solutions that can overcome the need for a companion alternator without adversely affecting performance. Accordingly, the present disclosure is directed at addressing one or more of the deficiencies and disadvantages set forth above. However, it should be appreciated that the solution of any particular problem is not a limitation on the scope of this disclosure or of the attached claims except to the extent expressly noted.

### SUMMARY OF THE DISCLOSURE

In one aspect of the present disclosure, a self-excitation system for a locomotive having at least a primary mover is provided. The self-excitation system may include a traction alternator, a permanent magnet machine, and a chopper circuit. The traction alternator may include an alternator stator and an alternator rotor mechanically coupled to a drive shaft of the primary mover. The permanent magnet machine may include a machine stator and a machine rotor mechanically coupled to the same drive shaft. The chopper circuit may be configured to receive electrical signals from the permanent magnet machine stator and control a field excitation of the traction alternator.

In another aspect of the present disclosure, an electric drive system for a locomotive having at least a primary mover and one or more loads is provided. The electric drive system may include a traction alternator, a permanent magnet machine, a chopper circuit, and a common bus. The traction alternator may include an alternator stator and an alternator rotor mechanically coupled to a drive shaft of the primary mover. The permanent magnet machine may include a machine stator and a machine rotor mechanically coupled to the drive shaft. The chopper circuit may be configured to receive electrical signals from the machine stator and control a field excitation of the traction alternator. The common bus may be in electrical communication between the alternator stator and the one or more loads.

In yet another aspect of the present disclosure, a locomotive is provided. The locomotive may include a primary mover having a drive shaft, a traction alternator operably coupled to the drive shaft, a permanent magnet machine operably coupled to the drive shaft, a chopper circuit configured to receive electrical signals from the permanent magnet machine and control a field excitation of the traction alternator, a traction system having a traction circuit and one or more traction motors, and a common bus in electrical communication between the traction alternator and the traction system.

### BRIEF DESCRIPTION OF THE DRAWINGS

FIG. 1 is a diagrammatic illustration of one exemplary electric drive system with a self-excitation system of the present disclosure as applied to a locomotive;

FIG. 2 is a schematic illustration of one exemplary electric drive system with a self-excitation system of the present disclosure; and

FIG. 3 is a diagrammatic illustration of one exemplary self-excitation system of the present disclosure having a permanent magnet machine, traction alternator and a chopper circuit.

### DETAILED DESCRIPTION

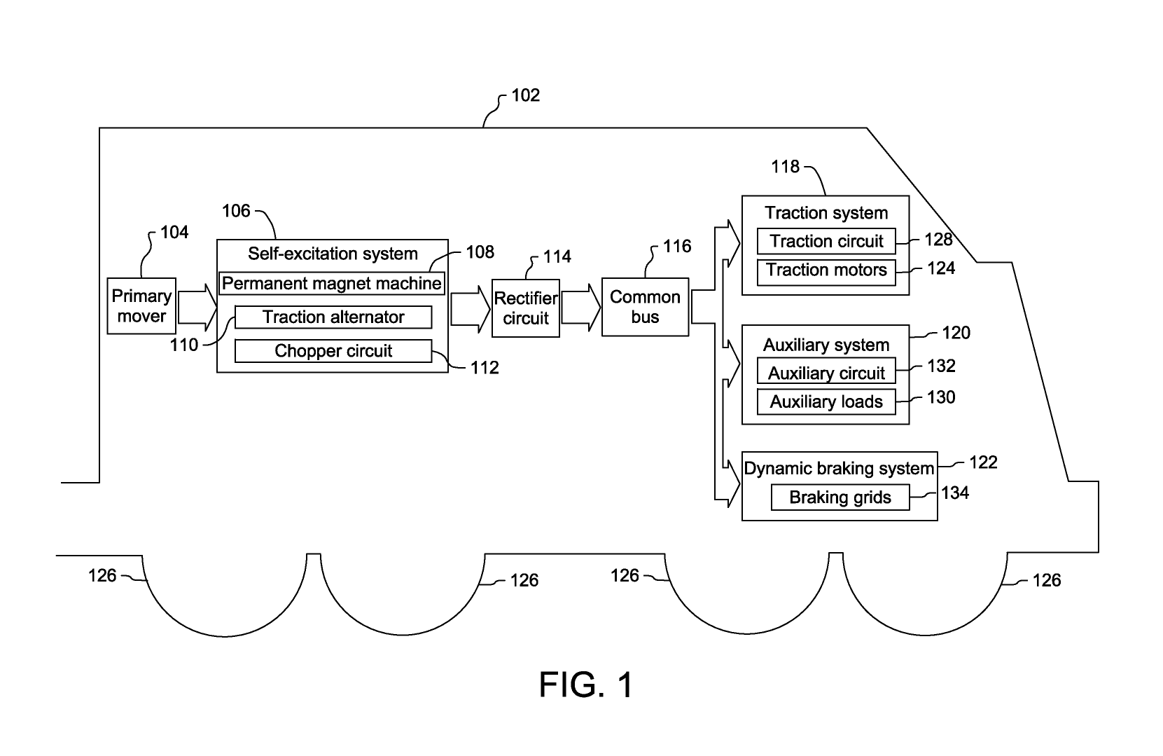

Referring now to FIG. 1, one exemplary embodiment of an electric drive system 100 for a railroad locomotive 102 is provided. Although the electric drive system 100 is shown as implemented in a locomotive 102, it will be understood that the electric drive system 100 may be applicable to and implemented in other types of mobile machines, suitable stationary machines, and the like. As shown, the electric drive system 100 may include at least a primary mover 104, such as a diesel engine, a gasoline engine, a gaseous-fuel driven engine, a turbine engine, or any other type of engine known in the art configured to combust fuel to produce a mechanical power output. The electric drive system 100 may also include a self-excitation system 106 having an arrangement of a permanent magnet machine 108, a traction alternator 110 and a chopper circuit 112, which collectively generates electrical power based on the mechanical power supplied by the primary mover 104, as will be discussed in more detail further below.

As shown in FIG. 1, the electric drive system 100 may further include a rectifier circuit 114 configured to convert the electrical power output by the self-excitation system 106 into an appropriate voltage for supporting one or more of a variety of loads of the electric drive system 100. For example, the rectifier circuit 114 may convert alternating current (AC) voltage signals received from the self-excitation system 106 into a direct current (DC) bus voltage to be communicated through a common bus 116. In turn, the common bus 116 may be configured to electrically couple the DC bus voltage to one or more of a traction system 118, an auxiliary system 120, a braking system 122, and any other load of the electric drive system 100. More particularly, each of the traction system 118, auxiliary system 120, and braking system 122, may be coupled in electrical parallel to the common bus 116. Alternatively, other loads may be coupled to the common bus 116 and other suitable arrangements of connections may be possible.

Still referring to FIG. 1, the traction system 118 may generally include one or more traction motors 124 that are operatively coupled to one or more traction devices 126 of the locomotive 102, such as wheels that ride on a rail. Moreover, the traction motors 124 may be configured to convert electrical energy into mechanical energy so as to drive the traction devices 126 and propel the locomotive 102 in response to throttle commands received from an operator of the locomotive 102. The traction system 118 may further include a traction circuit 128 configured to couple the traction motors 124 to the common bus 116 and supply the DC bus voltage to the each of the traction motors 124. In embodiments employing three-phase AC traction motors 124, for instance, the traction circuit 128 may include one or more inverters, or any other suitable circuit arrangement, suited to convert the DC bus voltage into the appropriate three-phase AC voltage signals for driving the traction motors 124. Correspondingly, other types or arrangements of traction motors 124 may be supported by other suitable types of traction circuits 128.

Additionally, the auxiliary system 120 FIG. 1 may generally include one or more auxiliary loads 130 of the locomotive 102 that are coupled to the electric drive system 100. For example, the auxiliary loads 130 may include any one or more of cooling fans, blowers, auxiliary power converters, lighting systems, heating, ventilation and air conditioning (HVAC) systems, and the like. The auxiliary system 120 may also include an auxiliary circuit 132 configured to electrically couple each of the auxiliary loads 130 to the common bus 116. For example, the auxiliary circuit 132 may include any suitable combination of inverters, filters, transformers and rectifiers commonly used in the art to convert the DC bus voltage into the appropriate AC and/or DC voltage signals needed to operate each of the auxiliary loads 130. Furthermore, the braking system 122 in FIG. 1 may include braking grids 134, or resistive circuits selectively coupled in parallel with the common bus 116 for dynamic braking modes of operation, as is commonly used for locomotives 102.

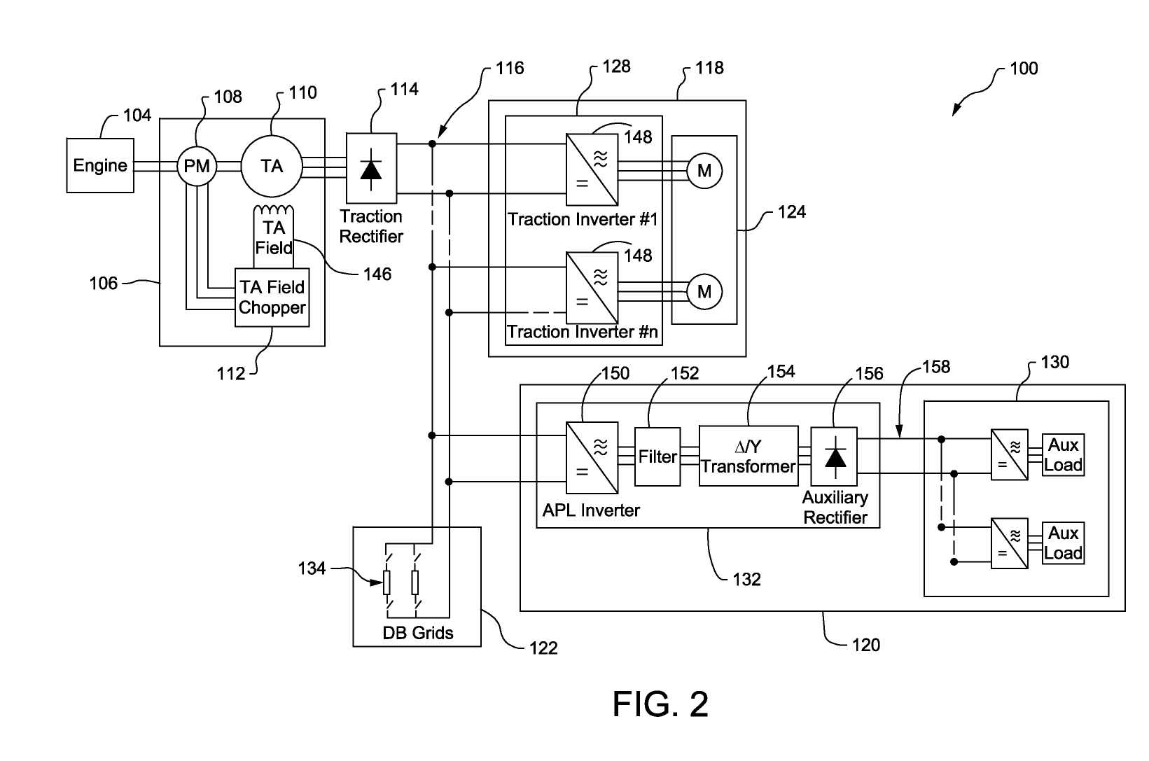

Turning to FIG. 2, one exemplary embodiment of an electric drive system 100 employing a self-excitation system 106 is shown in more detail. Similar to the embodiment of FIG. 1, the electric drive system 100 of FIG. 2 additionally includes a primary mover or engine 104, a rectifier circuit 114, a common bus 116, a traction system 118, an auxiliary system 120 and a braking system 122. Notably, the excitation system 106 is self-supporting, or capable of power itself without the need for an additional alternator, such as a companion alternator, and without the need for a feedback loop system as in the prior art. More specifically, similar to the embodiment of FIG. 1, the self-excitation system 106 in FIG. 2 simply includes an arrangement of a permanent magnet machine 108, a traction alternator 110 and a chopper circuit 112, which communicates with nothing more than the primary mover or engine 104 and the rectifier circuit 114.

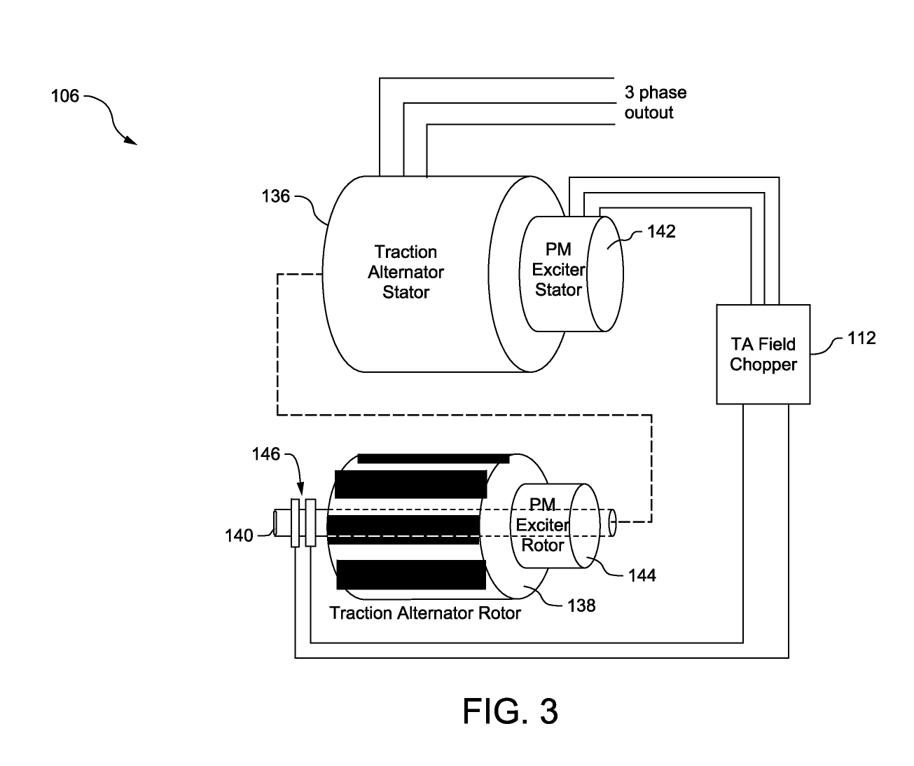

As more particularly shown for example in FIG. 3, the traction alternator 110 may include an alternator stator 136 and an alternator rotor 138 that is mechanically coupled to a drive shaft 140 of the primary mover or engine 104 and rotatably disposed within the alternator stator 136. The permanent magnet machine 108 may similarly include a machine stator 142 and a machine rotor 144 that is also mechanically coupled to the drive shaft 140 and rotatably disposed within the machine stator 142. Additionally, the chopper circuit 112 may be disposed in electrical communication between the machine stator 142 of the permanent magnet machine 108 and the alternator rotor 138 of the traction alternator 110. Furthermore, the ultimate output of the self-excitation system 106, or the output of the alternator stator 136 of the traction alternator 110, may be electrically coupled to the rectifier circuit 114, and thus the common bus 116 of the electric drive system 100 shown for instance in FIG. 2.

### INDUSTRIAL APPLICABILITY

In general terms, the present disclosure sets forth techniques for controlling an electric drive system 100 of a locomotive 102. Although applicable to any type of electric drive or power train associated with stationary or mobile machines, the present disclosure may be particularly applicable to electric drives or power trains for locomotives 102. Moreover, the present disclosure employs a permanent magnet machine 108 that is mechanically driven by a primary mover 104 and electrically coupled to a chopper circuit 112 to generate the field excitation needed to operate a traction alternator 110. The traction alternator 110 is thereby self-excited and does not need to rely on companion alternators or feedback loop systems in order to provide a bus voltage. Furthermore, because the traction alternator 110 is self-excited, risks of adverse interference from other high-voltage circuitry within the electric drive system 100 are diminished.

In one exemplary application, during operation of the self-excitation system 106 of FIG. 3, mechanical input provided by the drive shaft 140 of the engine 104 may cause the machine rotor 144 to rotate within the machine stator 142 and electromagnetically interact therewith so as to induce three-phase AC voltage signals within the machine stator 142. The chopper circuit 112 may be configured to receive the AC voltage signals from the machine stator 142, and convert the AC voltage signals into DC voltage signals in a manner appropriate for controlling a field excitation of the traction alternator 110. For example, the chopper circuit 112 may include circuits for switching, chopping or otherwise converting AC voltage signals into appropriately sequenced DC voltage signals that are electrically communicated to the alternator rotor 138 via one or more field coils 146. The chopper circuit 112 may thereby cause electromagnetic interactions between the alternator rotor 138 and the alternator stator 136, and induce three-phase AC voltage signals within the alternator stator 136 in response to the field excitation.

Turning back to FIG. 2, the three-phase AC voltage signals that are output by the self-excitation system 106, as illustrated in FIG. 3 for example, may further be converted into the appropriate DC bus voltage by the rectifier circuit 114. As described with respect to FIG. 1, the common bus 116 may communicate the DC bus voltage to each of the traction system 118, auxiliary system 120 and the braking system 122 via electrically parallel connections, or the like. As further shown in FIG. 2, the DC bus voltage may be supplied in parallel to each of a plurality of traction inverters 148 of the traction circuit 128 to be converted into appropriate AC voltage signals for driving the respective traction motors 124. The DC bus voltage may similarly be supplied, such as in electrical parallel, to each of the auxiliary system 120, the braking system 122, and any other load of the locomotive 102 that may be supported by the electric drive system 100.

More specifically, as shown in FIG. 2, the DC bus voltage may be supplied to the auxiliary circuit 132 to be adjusted into DC voltages appropriate sized for the attached auxiliary loads 130. For example, the auxiliary system 120 may include an auxiliary inverter 150 configured to initially convert the DC bus voltage into intermediary AC voltage signals. The intermediary AC voltage signals may then be filtered using one or more filters 152, and then stepped up or down by one or more transformers 154 of the auxiliary circuit 132. Additionally, the auxiliary circuit 132 may further include one or more auxiliary rectifiers 156 configured to convert the intermediary AC voltage signals an back into DC voltage signals that are more appropriate for the connected auxiliary loads 130. The auxiliary system 120 may also thereby provide a secondary common bus 158 that is electrically shared or substantially parallel to each of the connected auxiliary loads 130 as shown. Similarly, the DC bus voltage may be selectively supplied in parallel to the braking grids 134 of the braking system 122 as needed, such as during dynamic braking.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A self-excitation system for a locomotive having at least a primary mover, comprising:
a traction alternator having an alternator stator and an alternator rotor mechanically coupled to a drive shaft of the primary mover;
a permanent magnet machine having a machine stator and a machine rotor mechanically coupled to the drive shaft; and
a chopper circuit configured to receive electrical signals from the machine stator and control a field excitation of the traction alternator.

2. The self-excitation system of claim 1, wherein the machine rotor is rotatably driven by the drive shaft to induce alternating current signals in the machine stator.

3. The self-excitation system of claim 1, wherein the chopper circuit is configured to receive alternating current signals from the machine stator and output direct current signals to the alternator rotor to control the field excitation of the traction alternator.

4. The self-excitation system of claim 1, wherein the alternator rotor is configured to induce alternating current signals in the alternator stator in response to the field excitation.

5. The self-excitation system of claim 1, wherein the chopper circuit is configured to electrically communicate with the alternator rotor via one or more field coils.

6. The self-excitation system of claim 1, wherein the alternator stator is configured to output three-phase alternating current signals.

7. An electric drive system for a locomotive having at least a primary mover and one or more loads, comprising:
a traction alternator having an alternator stator and an alternator rotor mechanically coupled to a drive shaft of the primary mover;
a permanent magnet machine having a machine stator and a machine rotor mechanically coupled to the drive shaft;
a chopper circuit configured to receive electrical signals from the machine stator and control a field excitation of the traction alternator; and
a common bus in electrical communication between the alternator stator and the one or more loads.

8. The electric drive system of claim 7, wherein the machine rotor is rotatably driven by the drive shaft to induce alternating current signals in the machine stator, the chopper circuit being configured to receive the alternating current signals from the machine stator and output direct current signals to the alternator rotor to control the field excitation of the traction alternator, the alternator rotor being configured to induce alternating current signals in the alternator stator in response to the field excitation.

9. The electric drive system of claim 7, wherein the common bus includes a rectifier circuit configured to convert alternating current from the alternator stator to direct current.

10. The electric drive system of claim 7, wherein the common bus is configured to communicate direct current to one or more of a traction system, an auxiliary system and a dynamic braking system of the locomotive.

11. The electric drive system of claim 10, wherein the traction system includes a traction circuit and one or more traction motors, the traction circuit being configured to convert direct current in the common bus into alternating current suited to operate the traction motors.

12. The electric drive system of claim 10, wherein the auxiliary system includes an auxiliary circuit and one or more auxiliary loads, the auxiliary circuit being configured to convert direct current in the common bus into direct current suitable for operating the auxiliary loads.

13. The electric drive system of claim 7, wherein the chopper circuit is configured to electrically communicate with the alternator rotor via one or more field coils.

14. A locomotive, comprising:
a primary mover having a drive shaft;
a traction alternator operably coupled to the drive shaft;
a permanent magnet machine operably coupled to the drive shaft;
a chopper circuit configured to receive electrical signals from the permanent magnet machine and control a field excitation of the traction alternator;
a traction system having a traction circuit and one or more traction motors; and
a common bus in electrical communication between the traction alternator and the traction system.

15. The locomotive of claim 14, wherein the traction alternator includes an alternator stator and an alternator rotor mechanically coupled to the drive shaft, and the permanent magnet machine includes a machine stator and a machine rotor mechanically coupled to the drive shaft.

16. The locomotive of claim 14, wherein the common bus includes a rectifier circuit configured to convert alternating current from the traction alternator to direct current.

17. The locomotive of claim 14, wherein the traction circuit includes at least one traction inverter coupled to each traction motor, each traction inverter being configured to convert direct current in the common bus into alternating current for operating the associated traction motor.

18. The locomotive of claim 14, wherein the traction motors are configured to convert electrical energy into mechanical energy suited to cause movement of the locomotive using one or more traction devices.

19. The locomotive of claim 14, further comprising an auxiliary system having an auxiliary circuit and one or more auxiliary loads, the auxiliary circuit including one or more of auxiliary inverters, filters, transformers, and auxiliary rectifiers configured to convert direct current from the common bus into direct current suitable for operating the auxiliary loads.

20. The locomotive of claim 14, further comprising a dynamic braking system in electrical communication with the common bus.
